(19) United States
(12) Patent Application Publication
(10) Pub. No.: US 2023/0109340 A1
(43) Pub. Date: Apr. 6, 2023

(54) STOPPED VEHICLE COMFORT

(71) Applicant: GM Global Technology Operations LLC, Detroit, MI (US)

(72) Inventor: Donald K. Grimm, Utica, MI (US)

(21) Appl. No.: 17/491,864

(22) Filed: Oct. 1, 2021

(51) Int. Cl. G08G 1/01; B60W 30/18

(52) U.S. Cl. CPC G08G 1/0125; B60W 30/18; G08G 1/0145; B60W 2510/0638

(57) ABSTRACT

A system to mitigate side-to-side movement of a vehicle induced by passing traffic includes a controller configured to receive vehicle speed information, a traffic sensing system in communication with the controller, a damping system in communication with the controller, and at least one controllable damper in communication with the damping system. The controller determines if the vehicle speed is less than a predetermined minimum vehicle speed threshold, determines if the vehicle is in the proximity of nearby traffic, determines if the nearby traffic is traveling at a speed above a predetermined traffic speed threshold, and commands increased damping at the at least one controllable damper.

### INTRODUCTION

The present disclosure relates to improving the comfort experienced by an occupant of a stopped vehicle.

When a motor vehicle is stopped at a location that is near other vehicular traffic, the motion of the passing traffic may induce wind pressure on the stopped motor vehicle that may result in undesirable side to side vehicle movement.

Thus, while current vehicle systems achieve their intended purpose, there is a need for a new and improved system and method for improving the comfort experienced by an occupant of a stopped vehicle.

### SUMMARY

According to several aspects, a system is disclosed to mitigate movement of a passenger compartment of a vehicle, where the movement induced by passing traffic. The system includes a controller configured to receive vehicle speed information, a traffic sensing system in communication with the controller, a damping system in communication with the controller, and at least one controllable damper in communication with the damping system. The controller includes a processor and a non-transitory machine-readable storage device containing instructions that, when executed by the processor, cause the processor to determine if the vehicle speed is less than a predetermined minimum vehicle speed threshold, determine if the traffic sensing system indicates that the vehicle is in a location adjacent to high-speed traffic, and responsive to determining that the vehicle speed is less than the predetermined minimum vehicle speed threshold and that the vehicle is in a location adjacent to high-speed traffic, command increased damping at the at least one controllable damper.

In an additional aspect of the present disclosure, the traffic sensing system comprises at least one sensor mounted on the vehicle.

In another aspect of the present disclosure, the at least one sensor is a camera, a radar transducer, or a LIDAR transducer.

In a further aspect of the present disclosure, the traffic sensing system comprises a map database.

In an additional aspect of the present disclosure, the map database includes information about the location of the vehicle derived from a GPS system.

In an additional aspect of the present disclosure, the map database further includes real-time information about traffic flow adjacent to of the location of the vehicle, the real-time information received by a telecommunication device.

In another aspect of the present disclosure, the map database further includes information about average traffic flow adjacent to the location of the vehicle, the information about average traffic flow received by a telecommunication device.

In a further aspect of the present disclosure, the information about average traffic flow further includes information about the time-of-day or day-of-week for which the average traffic flow information was calculated.

In an aspect of the present disclosure, the at least one controllable damper comprises a plurality of controllable dampers. The system is configurable to control one of the controllable dampers to a first damping value and to control another of the controllable dampers to a second damping value that is different than the first damping value.

In another aspect of the present disclosure, the instructions, when executed by the processor, further cause the processor to determine the location of the high-speed traffic relative to the vehicle and to select the first damping value and the second damping value based on the location of the high-speed traffic.

In an additional aspect of the present disclosure, the processor further commands reduced damping at the at least one controllable damper responsive to determining that the vehicle speed is not less than the predetermined minimum vehicle speed threshold or that the vehicle is not in a location adjacent to high-speed traffic.

According to several aspects, method for controlling damping of at least one controllable damper on a vehicle is disclosed. The method includes determining if the vehicle speed is less than a predetermined minimum vehicle speed threshold, determining if the vehicle is in a location adjacent to high-speed traffic, and responsive to determining that the vehicle speed is less than the predetermined minimum vehicle speed threshold and that the vehicle is in a location adjacent to high-speed traffic, commanding increased damping at the at least one controllable damper.

In another aspect of the disclosed method, the step of determining if the vehicle is in a location adjacent to high-speed traffic utilizes information from at least one sensor mounted on the vehicle.

In another aspect of the disclosed method, the step of determining if the vehicle is in a location adjacent to high-speed traffic utilizes information from a map database.

In an additional aspect of the disclosed method, the information from the map database comprises real-time information about traffic flow in the vicinity of the location of the vehicle, the real-time information received by a telecommunication device.

In a further aspect of the disclosed method, the information from the map database comprises information about average traffic flow in the vicinity of the location of the vehicle, the information about average traffic flow received by a telecommunication device.

In another aspect of the disclosed method, the at least one controllable damper comprises a plurality of controllable dampers, wherein one of the controllable dampers is controllable to a first damping value and another of the controllable dampers is controllable to a second damping value that is different than the first damping value.

In a further aspect of the disclosed method, the method further includes determining the location of the high-speed traffic relative to the vehicle and selecting the first damping value and the second damping value based on the location of the high-speed traffic.

Further areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

The drawings described herein are for illustration purposes only and are not intended to limit the scope of the present disclosure in any way.

FIG. 1 is a plan view illustrating relative locations of a stopped vehicle and passing traffic according to an exemplary embodiment;

FIG. 2 is a block diagram of a system to control suspension dampers according to an exemplary embodiment;

FIG. 3 is a flow chart of a method to control suspension dampers according to an exemplary embodiment;

FIG. 4 is a graph comparing measured lateral acceleration on a stopped vehicle induced by a passing vehicle at two different suspension damping settings according to an exemplary embodiment.

### DETAILED DESCRIPTION

The following description is merely exemplary in nature and is not intended to limit the present disclosure, application, or uses.

In order to improve ride comfort in a moving vehicle, the vehicle may use technology that adapts and adjusts the damping of shock absorbers (also referred to herein as “dampers”) on the vehicle in real-time in response to road conditions in order to deliver optimal shock damping for the best possible driving experience. An example of such a technology utilizes controllable dampers containing magnetorheological fluid that is a mixture of iron particles in a synthetic hydrocarbon oil. Each controllable damper contains at least one electromagnetic coil and a piston with small fluid passages through the piston. The electromagnets are capable of creating a variable magnetic field across the fluid passages. When the electromagnets are not energized, the fluid travels through the passages freely. When the electromagnets are energized, the strength of the bonds between the magnetized iron particles causes the viscosity of the fluid to increase, resulting in a stiffer suspension. Altering the strength of the current through the electromagnet results in a change in damping behavior. Other variable damping technologies including but not limited to electrorheological and electromagnetic dampers may alternatively be used in a ride control system.

A moving vehicle affects the pressure of air that surrounds the moving vehicle. Wind drag that builds in front of a moving vehicle results in a high-pressure region in the vicinity of the front of the vehicle that can affect adjacent vehicles. When a passenger vehicle is stopped, i.e., the wheels of the vehicle are not moving relative to the ground, and there is passing traffic in an adjacent lane, the resulting wind pressure from the passing traffic can impart forces on the stopped vehicle causing side-to-side motion of the body of the stopped vehicle. In particular, the passenger compartment of the car is coupled to the wheels and tires of the car by a suspension system typically comprising springs and dampers, such that the passenger compartment is able to move relative to the ground even with the tires at a fixed location relative to the ground. Such side-to-side motion can result in an unpleasant sensation to an occupant of the stopped vehicle and may contribute to motion sickness. The imparted forces depend on such factors as the size of the passing vehicle, the speed of the passing vehicle, and the distance between the passing vehicle and the stopped vehicle.

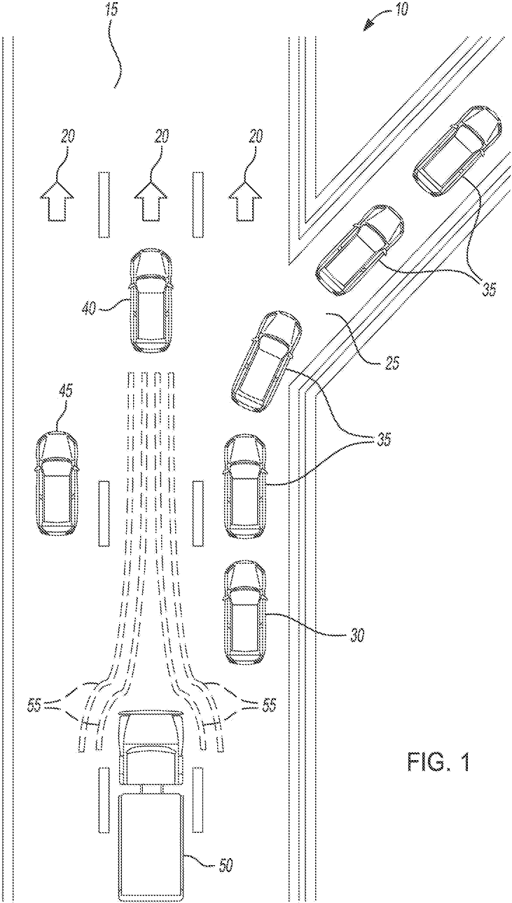

Referring to FIG. 1, a plan view 10 of a portion of an exemplary roadway 15 is presented. The exemplary roadway 15 accommodates three lanes of traffic in a direction indicated by the arrows 20. An exit ramp 25 is provided from the roadway 15. In the scenario illustrated in FIG. 1, a vehicle 30 is stopped in the right lane of the roadway 15 because of congestion in the form of stopped vehicles 35 exiting the roadway 15 on the exit ramp 25. Other vehicles 40, 45, 50 are shown in the left and center lanes of the roadway 15 moving in the direction indicated by the arrows 20. Air pressure perturbations 55 propagating from the moving vehicles 40, 45, 50 impart a lateral force to the stopped vehicle 30, resulting in side-to-side swaying or rocking of the stopped vehicle 30. While FIG. 1 illustrates a scenario in which the stopped vehicle 30 is in the rightmost traffic lane, it will be appreciated that similar motion of a stopped vehicle can be induced by other scenarios. For example, a vehicle may be stopped due to congestion on a leftward exiting ramp. Alternatively, a vehicle may be stopped waiting for oncoming traffic to clear so that a left turn can be completed. It will also be appreciated that the moving traffic may be approaching from behind the stopped vehicle as illustrated in FIG. 1, or may be oncoming relative to the stopped vehicle such as in a left turn event. It will be appreciated that motion of the stopped vehicle 30 may be induced by a non-highway vehicle, for example a railroad train moving in proximity to the stopped vehicle 30.

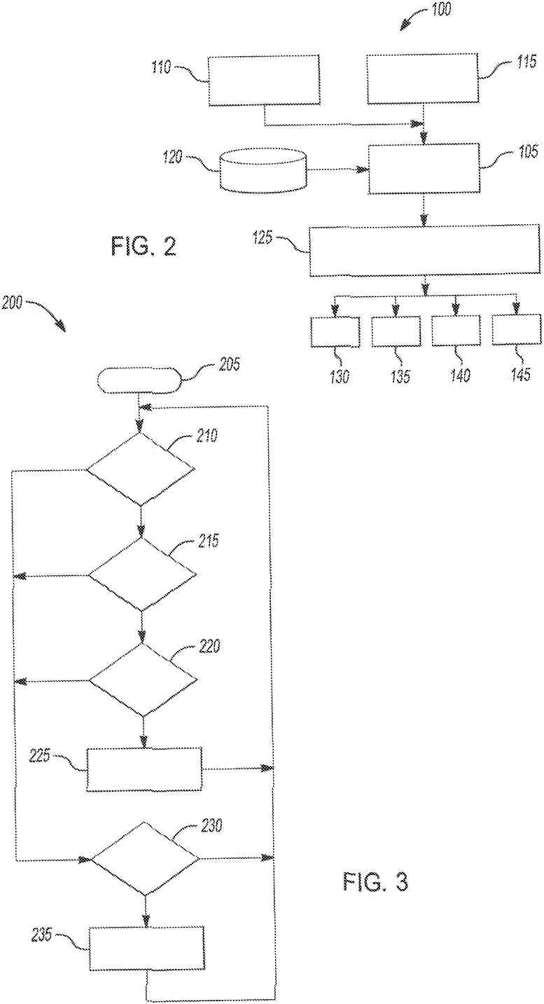

In an aspect of the present disclosure, a non-limiting depiction of a system to mitigate side-to-side swaying or rocking of a stopped vehicle is illustrated in FIG. 2. Referring to FIG. 2, the exemplary system 100 includes a controller 105 configured to receive digitally communicated information or measured voltage, current, position, temperature, and/or other suitable electrical value as part of a set of input signals. The controller 105 may be variously implemented as one or more control devices collectively managing the system 100 as part of the method 200 described below. Multiple controllers may be in communication via a serial bus, e.g., a CAN bus, other differential voltage networks, or via discrete conductors.

The controller 105 may include one or more digital computers each having a processor, e.g., a microprocessor or central processing unit, as well as memory in the form of read only memory, random access memory, electrically-programmable read only memory, etc., a high-speed clock, analog-to-digital and digital-to-analog circuitry, input/output circuitry and devices, and appropriate signal conditioning and buffering circuitry. The controller 105 may also store algorithms and/or computer executable instructions in memory, including the underlying algorithms or code embodying the method 200 described below, and transmit commands to various vehicle systems to enable performance of certain control actions according to the present disclosure.

The controller 105 is in communication with the vehicle 30 and may receive signals indicative of vehicle speed, transmission gear state, torque converter clutch state, and brake switch state as well as other possible vehicle operating conditions or parameters.

With continued reference to FIG. 2, the controller 105 is communicatively coupled to a first sensor 110 and to a second sensor 115. In an embodiment of the system 100, the first sensor 110 is a left-side object detection sensor and the second sensor 115 is a right-side object detection sensor that provide information to the controller about an approaching vehicle in an adjacent lane. Suitable technologies for the first sensor 110 and the second sensor 115 include camera, radar, and LIDAR.

The controller 105 is also depicted as communicatively coupled to a map database 120. The map database 120 contains lane-specific information for the location of the vehicle 30 as well as for lanes adjacent to the lane occupied by the vehicle 30. The information in the map database 120 may be provided by a GPS system in combination with analysis of vehicle telemetry data to identify if the vehicle 30 is in a location subject to another vehicle traveling at a high speed in an adjacent lane. The map database may receive lane-specific traffic speed information on a real-time basis by means of a telecommunication device. For example, a telematic system may collect and analyze location and speed data from a plurality of vehicles on the road to calculate traffic flow (lane speed and traffic density) for a traffic lane and to identify the likelihood of a lane adjacent to the vehicle 30 having high speed traffic. Alternatively, the map database 120 may collect average lane-specific traffic speed information over a period of time. It will be appreciated that average lane traffic speed is time dependent according to the time-of-day or day-of-week, for example due to commuter traffic patterns.

While FIG. 2 depicts object detection sensors 110 and 115 in conjunction with the map database 120, an implementation utilizing only object detection sensors 110, 115 without the map database 120, or having only the map database 120 without the object detection sensors 110, 115, is considered to be within the scope of the present disclosure.

With continued reference to FIG. 2, the controller 105 is communicatively coupled to a vehicle damping system 125 configured to provide a control signal to each of a plurality of controllable vehicle-mounted dampers including a left front damper 130, a right front damper 135, a left rear damper 140, and a right rear damper 145. The control signal to a controllable damper 130, 135, 140, 145 sets the damping behavior, i.e., softness or stiffness, of the controlled damper 130, 135, 140, 145. It will be appreciated that a damping value of the dampers 130, 135, 140, 145 can be controlled individually or in any combination to suit the situation. By way of non-limiting example, it may be advantageous to only stiffen the damping of the front dampers while leaving the rear dampers soft. In another non-limiting example, it may be desirable to stiffen the dampers on the left side of the vehicle 30 while leaving the right-side dampers soft. Selectively stiffening fewer than the entire number of dampers on the vehicle results in lower electrical current demand than stiffening all of the dampers on the vehicle 30.

Referring to FIG. 3, a flow chart of a method 200 to control the damping of the suspension dampers 130, 135, 140, 145 is depicted. The discussion of the method 200 is based on the assumption that the dampers 130, 135, 140, 145 employ a technology in which damping is increased by increasing current flow to the damper. After an initialization process at step 205, the method 200 proceeds to step 210 where it is determined whether the vehicle 30 is stopped. As used herein, the term “stopped” relative to the vehicle 30 also includes situations where the speed of the vehicle 30 is below a predefined, non-zero threshold. If it is determined in step 210 that the vehicle is not stopped, the method proceeds to step 230. If it is determined in step 210 that the vehicle 30 is stopped, the method proceeds to step 215.

In step 215, it is determined whether or not the vehicle 30 is in the proximity of nearby traffic. In an exemplary embodiment, this determination is based on information received from object detection sensors 110, 115 regarding proximity of traffic. In an alternative exemplary embodiment, the determination of whether or not the vehicle 30 is in the proximity of nearby traffic is based on analysis of vehicle telemetry data from the map database 120. If it is determined in step 215 that the vehicle is not is in the proximity of nearby traffic, the method proceeds to step 230. If it is determined in step 215 that the vehicle 30 is in the proximity of nearby traffic, the method proceeds to step 220.

With continued reference to FIG. 3, in step 220 it is determined if the difference in speed between the vehicle 30 and nearby traffic is above a predetermined minimum threshold. In an exemplary embodiment, this determination is based on information received from object detection sensors 110, 115 regarding proximity of traffic, with the time rate of change of proximity providing speed information. In an alternative exemplary embodiment, the determination of whether or not the difference in speed between the vehicle 30 and nearby traffic is based on analysis of vehicle telemetry data from the map database 120. If it is determined in step 220 that the difference in speed between the vehicle 30 and nearby traffic is not above the predetermined minimum threshold, the method proceeds to step 230. If it is determined in step 220 that the difference in speed between the vehicle 30 and nearby traffic is above the predetermined minimum threshold, the method proceeds to step 225.

Continuing to refer to FIG. 3, the method reaches step 225 if all of the following conditions are present; the vehicle 30 is stopped, the vehicle 30 is in the proximity of nearby traffic, and the difference in speed between the vehicle 30 and the nearby traffic is above a predetermined minimum threshold. When all three of these conditions are present, in step 225 the method sends a command to the vehicle damping system 125 to apply current to the suspension dampers 130, 135, 140, and/or 145 to reduce swaying or rocking of the vehicle 30. Following commanding the application of the current to the suspension dampers, the method returns to step 210.

As discussed above, the method 200 may reach step 230 if any one of the following three conditions are true: (1) the vehicle 30 is not stopped; (2) the vehicle 30 is not located in the proximity of traffic; or (3) the difference in speed between the vehicle 30 and nearby traffic is not above a predetermined minimum threshold. If the method 200 reaches step 230 this is an indication that suspension stiffening is not presently desired. Step 230 determines whether current is presently applied to any of the suspension dampers 130, 135, 140, 145. If current is not presently applied to any of the suspension dampers 130, 135, 140, 145, the method 200 returns to step 210. If current is presently applied to any of the suspension dampers 130, 135, 140, 145, the method 200 proceeds to step 235 in which current to the suspension dampers 130, 135, 140, 145 is removed. While removing the current to the suspension dampers is not required to achieve the benefits of the present disclosure, it is nonetheless desirable to conserve battery capacity. Following removal of the current to the suspension dampers 130, 135, 140, 144 in step 235, the method returns to step 210.

In a non-limiting exemplary embodiment, the step 210 may determine if the vehicle 30 is still traveling at a non-zero speed but is approaching a zero-speed condition, and if so, respond as if the vehicle is already totally stopped. Predicting an imminent stop of the vehicle 30 and starting the application of current to the suspension dampers 130, 135, 140, 145 early may be advantageous in compensating for the response time associated with initial stiffening of the suspension dampers 130, 135, 140, 145, thereby allowing the advantages of the present disclosure to occur earlier.

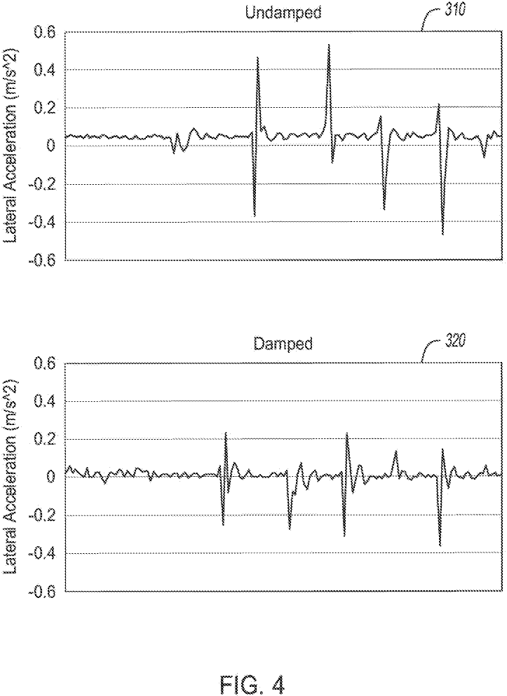

FIG. 4 is a comparison of measured lateral acceleration on a stopped vehicle 30 induced by a passing vehicle 50 at two different suspension damping settings according to an exemplary embodiment. The top graph 310 is a plot of lateral acceleration vs. time for a single passing event with the suspension of the vehicle 30 undamped. The bottom graph 320 is a plot of lateral acceleration vs. time for a single passing event with the suspension of the vehicle 30 damped in accordance with the method 200 described above. The same vertical scaling for lateral acceleration is used in both the top graph 310 and the bottom graph 320, and the time durations captured on the horizontal axes of the top graph 310 and the bottom graph 320 are comparable. The data depicted on both the top graph 310 and the bottom graph 320 were measured with the same vehicle 50 passing the vehicle 30 at the same speed. As demonstrated by the data presented in FIG. 4, providing additional damping significantly reduces lateral acceleration induced by a passing vehicle 50.

A system to mitigate side-to-side swaying or rocking of a stopped vehicle of the present disclosure offers several advantages. One benefit is a more refined customer experience due to minimized vehicle movement. Another benefit is a reduction in occupant motion sickness effects caused by unpredictable vehicle movements. Yet another benefit is a perception of improved vehicle quality due to a feeling of improved vehicle stability.

The description of the present disclosure is merely exemplary in nature and variations that do not depart from the gist of the present disclosure are intended to be within the scope of the present disclosure. Such variations are not to be regarded as a departure from the spirit and scope of the present disclosure.

What is claimed is:

1. A system to mitigate movement of a passenger compartment of a vehicle, said movement induced by passing traffic, the system comprising:
a controller configured to receive vehicle speed information;
a traffic sensing system in communication with the controller;
a damping system in communication with the controller; and
at least one controllable damper in communication with the damping system;
wherein the controller comprises a processor and a non-transitory machine-readable storage device containing instructions that, when executed by the processor, cause the processor to:
determine if the vehicle speed is less than a predetermined minimum vehicle speed threshold;
determine if the traffic sensing system indicates that the vehicle is in a location adjacent to high-speed traffic; and
responsive to determining that the vehicle speed is less than the predetermined minimum vehicle speed threshold and that the vehicle is in a location adjacent to high-speed traffic, command increased damping at the at least one controllable damper.

2. The system of claim 1, wherein the traffic sensing system comprises at least one sensor mounted on the vehicle.

3. The system of claim 2, wherein the at least one sensor is a camera, a radar transducer, or a LIDAR transducer.

4. The system of claim 1, wherein the traffic sensing system comprises a map database.

5. The system of claim 4, wherein the map database includes information about the location of the vehicle derived from a GPS system.

6. The system of claim 5 wherein the map database further includes real-time information about traffic flow adjacent to of the location of the vehicle, the real-time information received by a telecommunication device.

7. The system of claim 5 wherein the map database further includes information about average traffic flow adjacent to the location of the vehicle, the information about average traffic flow received by a telecommunication device.

8. The system of claim 7 wherein the information about average traffic flow further includes information about the time-of-day or day-of-week for which the average traffic flow information was calculated.

9. The system of claim 1, wherein the at least one controllable damper comprises a plurality of controllable dampers, wherein the system is configurable to control one of the plurality of controllable dampers to a first damping value and to control another of the plurality of controllable dampers to a second damping value that is different than the first damping value.

10. The system of claim 9, wherein the instructions that, when executed by the processor, further cause the processor to determine the location of the high-speed traffic relative to the vehicle and to select the first damping value and the second damping value based on the location of the high-speed traffic.

11. The system of claim 1, wherein the processor further commands reduced damping at the at least one controllable damper responsive to determining that the vehicle speed is not less than the predetermined minimum vehicle speed threshold or that the vehicle is not in a location adjacent to high-speed traffic.

12. A method for controlling damping of at least one controllable damper on a vehicle, the method comprising the steps of:
determining if the vehicle speed is less than a predetermined minimum vehicle speed threshold;
determining if the vehicle is in a location adjacent to high-speed traffic; and
responsive to determining that the vehicle speed is less than the predetermined minimum vehicle speed threshold and that the vehicle is in a location adjacent to high-speed traffic, commanding increased damping at the at least one controllable damper.

13. The method of claim 12, wherein the step of determining if the vehicle is in a location adjacent to high-speed traffic utilizes information from at least one sensor mounted on the vehicle.

14. The method of claim 12, wherein the step of determining if the vehicle is in a location adjacent to high-speed traffic utilizes information from a map database.

15. The method of claim 14, wherein the information from the map database comprises real-time information about traffic flow in the vicinity of the location of the vehicle, the real-time information received by a telecommunication device.

16. The method of claim 14, wherein the information from the map database comprises information about average traffic flow in the vicinity of the location of the vehicle, the information about average traffic flow received by a telecommunication device.

17. The method of claim 12, wherein the at least one controllable damper comprises a plurality of controllable dampers, wherein one of the plurality of controllable dampers is controllable to a first damping value and another of the plurality of controllable dampers is controllable to a second damping value that is different than the first damping value.

18. The method of claim 17, wherein the method further includes determining the location of the high-speed traffic relative to the vehicle and selecting the first damping value and the second damping value based on the location of the high-speed traffic.
